(19) United States
(12) Patent Application Publication
(10) Pub. No.: US 2009/0050047 A1
(43) Pub. Date: Feb. 26, 2009

(54) Display Device for Chilled Goods

(76) Inventor: Philipp Wotzer, Mieming (AT)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/083,716

(22) PCT Filed: Oct. 16, 2006
(86) PCT No.: PCT/EP2006/009977

§ 371 Date: Oct. 6, 2008

(30) Foreign Application Priority Data
Oct. 17, 2005 (AT) A 1693/2005

(51) Int. Cl. G01D 21/00

(52) U.S. Cl. 116/207

(57) ABSTRACT

A display device (1) for chilled goods (2), in particular for food subjected to a cooling chain, comprising a reaction fluid (4) within a liquid-tight receptacle (3) and an absorbent display element (5), wherein the receptacle (3) is destructible by a change in volume of the reaction fluid (4) if the temperature falls below an adjustable value and the appearance of the display element (5) is irreversibly alterable by the liquefied reaction fluid (4), wherein between the receptacle (3) and the display element (5) a delay means (6) is formed or arranged by means of which the period between liquefaction of the reaction fluid (4) on account of a temperature rise and the change in appearance of the display element (5) on account of a contact with the liquefied reaction fluid (4) are reversibly adjustable.

The present invention relates to a display device for chilled goods, in particular for food subjected to a cooling chain, comprising a reaction fluid within a liquid-tight receptacle and an absorbent display element, wherein the receptacle is destructible by a change in volume of the reaction fluid if the temperature falls below an adjustable value and the appearance of the display element is irreversibly alterable by the liquefied reaction fluid.

In particular in the field of chilled food, the so-called cooling chain from the production to the time of purchase may be broken. The cooling chain can, e.g., be broken by too long dwell times of the deep-frozen goods outside the cold stores or, for example, at the point of sale.

So as to give the consumer the possibility of controlling whether the deep-frozen goods he/she bought have once or several times been damaged by intermediate thawing, it is known to provide deep-frozen food with display devices that irreversibly change their appearance if the deep-frozen product has thawed beyond a certain temperature so that is recognisable from outside whether the cooling chain was broken.

The solutions known so far, on the one hand, were too expensive and elaborate to be used in individual packages of bulk articles. On the other hand, they were disadvantageous in that in case of food packaged in cardboard the reaction fluid thawed on account of the ambient temperature of the cardboard so that the display device changed its appearance without the temperature of the chilled goods having exceeded the temperature threshold.

It is therefore the object of the present invention to provide a display device that may be produced simply and at low cost and reliably indicates an interruption of the cooling chain of the chilled goods without showing the aforementioned disadvantages.

According to the invention, this object is achieved in that a delay means is formed or arranged between the receptacle and the display element. By means of this delay means, the period of time between liquefaction of the reaction fluid on account of a temperature rise and change in appearance of the display element due to a contact with the liquefied reaction fluid is reversibly adjustable. Thus, the change in appearance of the display element is adaptable to different types of chilled goods, such as deep-frozen food.

According to a further embodiment of the present invention, the delay means is adapted to absorb the entire liquefied reaction fluid and the appearance of the display element is not changed until the delay means has absorbed the entire liquefied reaction fluid. This prevents the display element from irreversibly changing more or less simultaneously with the first formation of condensate when the reaction fluid is thawing, as is the case according to the prior art. Rather, the appearance of the display element is only irreversibly changed if the chilled goods also exceed a predetermined temperature.

To this end, the amount of reaction fluid may be adjusted to the length of the delay means, i.e. the delay means is adapted to absorb the entire liquefied reaction fluid so that the appearance of the display element is not changed before the entire reaction fluid is liquefied and has been absorbed by the delay means. Thus, it is ensured that a colour change of the display element is connected with the temperature of the chilled goods.

According to a structurally simple solution according to which the liquefied reaction fluid can moreover be collected, the receptacle with the reaction fluid, the delay means and the absorbent display element are provided in a container that is open to the top and is or can be closed in a liquid-tight manner with a cover element. Advantageously, the container is made of plastics, preferably a film, and the cover element, which is preferably made of a film, is at least in part transparent.

According to a further embodiment of the invention, the cover element is provided with a transparent, preferably cylindrical projection facing away from the receiving area of the container. Thus, the display device according to the invention can easily be mounted inside the package of the chilled goods, wherein the transparent projection of the cover element rests in a, for example, punched throughhole in the package. The display element is therefore recognisable from outside and is securely prevented from being removed or damaged.

According to a further embodiment, the display device according to the present invention can be produced at particularly low cost if the preferably discoid absorbent display element is made of cotton wool or paper, preferably litmus paper. Tests made by the applicants have shown that display elements in powder form, of chalk or display elements made of a sponge or felt are likewise suitable for realising the idea of the invention.

In other words, the liquefied reaction fluid in the display device is hindered on its way to the display element, which, according to an embodiment of the invention, is achieved in that the delay means is preferably made of compressed sponge.

Alternatively, the delay means may be multi-layer elements and may comprise at least one absorbent layer and at least one liquid impermeable layer as well as means for transporting the reaction fluid. So that the display device may be adjusted accurately, it has turned out to be favourable if the topmost layer facing the display element and/or the lowermost layer facing the receptacle of the delay means is liquid-impermeable.

On account of the liquid-impermeable layer(s), the liquid reaction fluid can no longer diffuse directly through the delay means but is transported via the transport means from the receiving area of the container over one or more absorbent layer of the delay means to the display element.

According to a further embodiment of the invention, a structurally simple solution is achieved if the means for transporting reaction fluid are formed by at least one throughhole in the liquid-impermeable layer(s) of the delay means. If the delay means comprises a plurality of liquid-impermeable layers, the throughholes of the various liquid-impermeable layers are favourably arranged incongruently. Thus, the reaction fluid can penetrate an absorbent layer through the subjacent throughhole, whereupon it has to soak this absorbent layer until it is capable of leaving this absorbent layer through the offset top throughhole.

According to a further embodiment of the invention, the means for transporting the reaction fluid are formed by a transport element with capillary action, preferably a textile fibre. Thus, the reaction fluid can only be transported from one absorbent layer to the next absorbent layer via the transport element. A combination of the two means for transporting the reaction fluid is of course also possible.

The period between liquefaction of the reaction fluid on account of a temperature rise and the change in appearance of the display element on account of a contact with the liquefied reaction fluid therefore can be adjusted by the number of absorbent or impermeable layers of the delay means. According to a preferred embodiment of the invention, the absorbent and liquid-impermeable layers are alternately arranged. In other words, the period is adjusted by a longer or shorter distance.

According to a further embodiment of the invention, this is also achieved if the delay means is formed by a film tube comprising absorbent material, preferably cotton wool, inside. Here, too, a longer distance, i.e. an altogether longer delay means, results in a later irreversible change in the appearance of the display element. Therefore, it has turned out favourable if the film tube is arranged such that it takes a meandering course between the receptacle and the display element.

According to a further embodiment of the invention, a particularly simple solution as regards the production technique is achieved if the display element and the delay means are made in one piece or formed integrally or if a transport element with capillary action, preferably a textile fibre, is arranged between the receptacle and the delay means.

The display device according to the present invention thus is a display device that is (only) attached to the package so that it neither penetrates nor extends towards the frozen goods. The display device according to the present invention therefore is a virtually contact-free or indirectly measuring display device where direct contact with the frozen goods is unnecessary.

According to the invention, indirect or contact-free measurement by the display device attached to the package is achieved by the delay means. The delay means obstructs the flow of the reaction fluid to the display device. On account of this very delayed transport of the reaction fluid to the display element, the display device, e.g., does not have to penetrate the frozen food but is merely attached to the package. Thus, without the frozen goods being penetrated, it is indirectly possible to take into account the core temperature or a transgression of the minimum core temperature of the frozen goods. Thus, display errors on account of an elevated ambient temperature are avoided.

The display device according to the invention is advantageous in that a correct display is possible irrespective of the size or thickness of the frozen goods.

Further advantages and details of the present invention will be illustrated by the description of the drawings with reference to the embodiments shown in the drawings, in which:

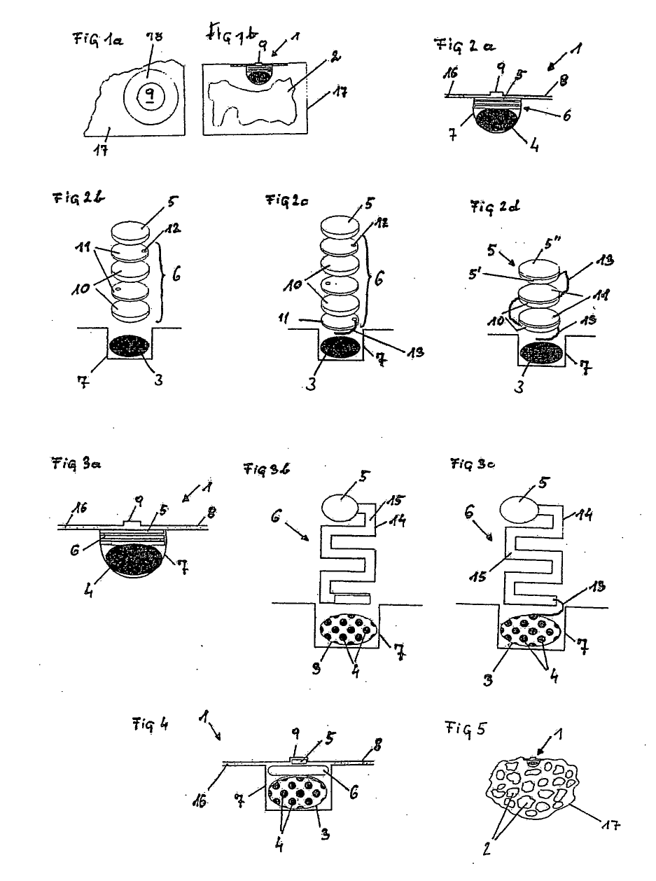

FIGS. 1a-1b show a packing unit for chilled goods comprising a display device according to the invention;

FIGS. 2a-2d show various examples of a first embodiment of the invention;

FIGS. 3a-3c show different examples of a second embodiment;

FIG. 4 shows a third embodiment of the invention; and

FIG. 5 shows a second packing unit for chilled goods comprising a display device according to the invention.

The packing unit 17 shown in FIGS. 1 and 1b is formed by a cardboard box comprising the chilled goods 2, such as deep-frozen food. It is irrelevant in this connection whether the chilled goods 2 are themselves packed or are loosely stored in the packing unit 17. FIG. 1a is a top view of the packing unit 17, which shows that a projection 9 of the display unit 1 arranged at, preferably glued to, the inner wall of the packing unit 17 is visible from outside through an, e.g., punched opening in the packing unit 17. The projection 9 which is cylindrical in the embodiment shown, is transparent and thus enables viewing the display element 5 arranged underneath the cover 8. The height of the cylindrical projection 9 approximately corresponds to the material thickness of the packing unit 17, wherein the top surface of the projection 9 which is visible from outside may be surrounded by a label 18 having an opening that approximately corresponds to the diameter of the projection 9. This label can simply be glued to the packing unit 17 and, e.g., serves for attaching consumer advices.

A display device 1 comprising a multi-layer delay means 6 is shown in FIGS. 2a-2d. FIG. 2a shows a cross-sectional view of the display device 1, according to which the reaction fluid 4, which, e.g., is made of water coloured by food colour, is shrink-wrapped in a receptacle 3, which is formed of a film in the embodiment shown. Therefore, the reaction fluid 4 can have room temperature when the chilled goods 2 are packed. When the packing unit 17 is deep-frozen, the reaction fluid 4 expands so that the receptacle 3 is destroyed by the change in volume. If the temperature of the chilled goods 2 rises when the cooling chain has been broken, the frozen reaction fluid 4 melts, is collected within the container 7 and is transported by the delay means 6 to the display element 5 where it is absorbed so that the appearance of the display element 5 is irreversibly changed.

According to FIG. 2b, the delay means 6 consists of a plurality of absorbent layers 10 and a plurality of liquid-impermeable layers 11, which are alternately arranged. The bottom end of the delay means 6 which faces the reaction fluid 4 is provided with an absorbent layer 10 through which the reaction fluid 4 enters the delay means 6. The liquid-impermeable layers 11, which are arranged between the absorbent layers 10 and, e.g., are made of a plastics film, are provided with at least one throughhole 12 through which the reaction fluid 4 passes from one absorbent layer 10 to the next absorbent layer 10. The throughholes 12 of adjacent liquid-impermeable layers 11 are offset and the time the reaction layer 4 requires to pass from one absorbent layer 10 to the next can be adjusted by the displacement angle.

The functional principle of the embodiment shown in FIG. 2c corresponds to the functional principle according to the embodiment shown in FIG. 2b. Therefore, it will not be described in detail in the following. It differs from the last embodiment in that the bottom end of the delay means 6 is provided with a liquid-impermeable layer 11 and the reaction fluid 4 enters the delay means 6 through the means 13, such as a textile fibre. The reaction fluid 4 is transported through the delay means 6 according to the embodiment according to FIG. 2b.

In the third embodiment of a multi-layer delay means 6 according to FIG. 2d, the layers of the delay means 6 are made of two parts and are each provided with an upper liquid-impermeable layer 11 and a lower absorbent layer 10. It is of course also possible to reverse the order of the layers. The essential feature of the invention consists in that the reaction fluid 4 cannot directly diffuse from one layer of the delay means 6 to the next on account of the liquid-impermeable layers 11 but is transported or transportable via transport means 13 that interconnect the absorbent layers 10 from one layer of the delay means into the next. Moreover, according to this embodiment, the display element 5 is also made of two parts and is provided with an absorbent layer 5′, such as cotton wool or litmus paper, facing the chilled goods 2 and a cover film 5″ covering this layer 5′.

FIGS. 3a-3c show a different embodiment of an inventive display device 1, wherein the delay means 6 is made of a film tube 14 within which absorbent material 15 is provided. The delay means 6 is arranged in a meandering course or on a wiggly line since the period required by the reaction fluid 4 to arrive at the display element 5 is adjusted by means of the length of the delay means 6. Thus, it is guaranteed that the colour of the display element 5 definitely is not changed before the temperature of the chilled goods exceeds the predetermined threshold or at the beginning of the melting process of the reaction fluid on account of a temperature rise outside the packing unit 17.

To this end, the length of the delay means 6 and the amount of reaction fluid 4 are preferably adapted to one another such that the delay means 6 absorbs the entire liquefied reaction fluid 4. Thus, the container 7 for collecting the liquefied reaction fluid 4 is empty before the appearance of the display element 5 is changed.

According to the embodiment shown in FIG. 3b, the film tube 14 of the delay means 5 is in part interrupted at the side facing the reaction fluid 4 so as to permit the reaction fluid 4 to enter the delay means 6.

In contrast, according to the embodiment shown in FIG. 3c, the film tube 14 of the delay means 5 is closed on the side facing the reaction fluid 4, and it is made sure by the transport means 13 that the reaction fluid 4 enters the delay means 6.

FIG. 4 shows a further embodiment of the display device 1 in which the delay means 6 is simply made of a sponge or compressed powder. However, with this structurally simple solution, it is more difficult to adjust the period the reaction fluid 4 requires to arrive at the display element 5 than with the aforementioned examples.

FIG. 5 shows a packing unit 17 made of a plastics film and comprising loosely packed chilled goods 2, such as deep-frozen food, e.g., vegetables or French fries, and a display device 1 according to the invention. In such packing units 17, which, as a rule, are made of a double heat-sealed film tube, the display device 1 can be arranged at, preferably heat-sealed to, the film tube before the film tube is filled with the chilled goods or heat-sealed.

The shown embodiments of a display device according to the invention are understood to be non-restrictive and constitute individual examples realising the inventive idea of a display device for chilled goods. It would, for example, also be possible to produce a display device adapted to the chilled goods by covering an absorbent, flat material, such as paper or cotton wool on both sides with a one-side adhesive film. Thus, a capillary action is generated if at least parts of the flat absorbent material are not covered by the film so as to enable an absorption of the reaction fluid. Such a delay means can simply be heat-welded to the container comprising the receptacle with the reaction fluid. Thus, a solution has been found that is particularly inexpensive, simple to produce and suitable for almost all deep-frozen products.

1. A display device for chilled goods, in particular food subjected to a cooling chain, comprising a reaction fluid provided in a liquid-tight receptacle and an absorbent display element, wherein the receptacle is destructible by a volume change of the reaction fluid if the temperature falls below an adjustable value and the appearance of the display element can be irreversibly changed by means of the liquefied reaction fluid, characterised in that between the receptacle (3) and the display element (5) a delay means (6) is formed or arranged by means of which the period between liquefaction of the reaction fluid (4) on account of a temperature rise and the change in the appearance of the display element (5) is reversibly adjustable on account of the contact with the liquefied reaction fluid (4).

2. The display device according to claim 1, wherein the delay means restricts the flow of the reaction fluid to the display element.

3. The display device according to claim 1 , wherein it is arranged at the package of the chilled goods.

4. The display device according to claim 1, characterised in that the delay means (6) is designed to absorb the entire liquefied reaction fluid (4), wherein the display element (5) does not change its appearance before the entire liquefied reaction fluid (4) is completely absorbed by the delay means (6).

5. The display device according to claim 1, characterised in that the receptacle (3) comprising the reaction fluid (4), the delay means (6) and the absorbent display element (5) are arranged in a container (7) that is open to the top and is closed or closable in a liquid-tight manner by means of a cover element (8).

6. The display device according to claim 5, characterised in that the container (7) is made of plastics, preferably a film.

7. The display device according to claim 5, characterised in that at least parts of the cover element (8), which is preferably made of a film, are transparent.

8. The display device according to claim 5, characterised in that the cover element (8) is provided with a transparent, preferably cylindrical projection (9) extending in a direction facing away from the receiving area of the container (7).

9. The display device according to claim 1, characterised in that the preferably discoid absorbent display element (5) is made of cotton wool or paper, preferably litmus paper.

10. The display device according to claim 1, characterised in that the delay means (6) is formed by a preferably compressed sponge.

11. The display device according to claim 1, characterised in that the delay means (6) is a multi-layer element and is provided with at least one absorbent layer (10) and at least one liquid-impermeable layer (11) as well as means (13) for transporting the reaction fluid (4).

12. The display device according to claim 11, characterised in that the topmost layer of the delay means (6) facing the display element (5) and/or its lowermost layer facing the receptacle (3) are liquid impermeable.

13. The display device according to claim 11, characterised in that the absorbent layer(s) (10) and the liquid-impermeable layer(s) (11) are alternately arranged on top of each other.

14. The display device according to claim 11, characterised in that the means for transporting the reaction fluid (4) are formed by at least one throughhole (12) within the liquid-impermeable layer(s) (11) of the delay means (6).

15. The display device according to claim 11, characterised in that the means for transporting the reaction fluid (4) are formed by a transport element (13) having capillary action, preferably a textile fibre.

16. The display device according to claim 1, characterised in that the delay means (6) is formed by a film tube (14) whose inside is provided with absorbent material (15), preferably cotton wool.

17. The display device according to claim 16, characterised in that the film tube (14) takes a meandering course between the receptacle (3) and the display element (5).

18. The display device according to claim 1, characterised in that the display element (5) and the delay means (6) are integrally formed.

19. The display device according to claim 1, characterised in that a transport element (13) having capillary action, preferably a textile fibre, is arranged between the receptacle (3) and the delay means (6).
